(19) United States
(12) Patent Application Publication
(10) Pub. No.: US 2026/0203533 A1
(43) Pub. Date: Jul. 16, 2026

(54) Generating and Integrating Sign Language Into Video Streams

(71) Applicant: Bitmovin GmbH, Klagenfurt am Wörthersee (AT)

(72) Inventors: Kevin Rocard, Vienna (AT); Jacob Arends, Bristol (GB); Jonathan Mogovan, Bistrita (RO); Mario Graf, Vienna (AT); Matthias Tamegger, Graz (AT)

(73) Assignee: Bitmovin GmbH, Klagenfurt am Wörthersee (AT)

(21) Appl. No.: 19/445,310

(22) Filed: Jan. 9, 2026

Related U.S. Application Data
(60) Provisional application No. 63/743,963, filed on Jan. 10, 2025.

(51) Int. Cl. G06F 40/58; G06T 13/40

(52) U.S. Cl. CPC G06F 40/58; G06T 13/40

(57) ABSTRACT

Techniques relating to generating and integrating sign language into video streams are disclosed. A system for generating and integrating sign language into video streams may include a server-side processor comprising an NLP and/or AI model and a client-side processor comprising a video player, a gesture translator, and an avatar rendering engine. A method performed by this system may include generating an intermediate representation based on a subtitle text track associated with a video track, converting the intermediate representation into a standardized transcription representation, and generating a sign language subtitle package comprising the standardized transcription representation and timing information, converting the standardized transcription representation into a signing gesture language description, and rendering an avatar, the avatar being animated using the signing gesture language description to perform sign language gestures in real time with the video. The avatar may be customizable from either or both the client side and the server side.

### CROSS-REFERENCE TO RELATED APPLICATIONS

This application claims the benefit of U.S. Provisional Patent Application No. 63/743,963 entitled “System and Method for Generating and Integrating Sign Language into Video Streams,” filed Jan. 10, 2025, the contents of which are hereby incorporated by reference in their entirety.

### BACKGROUND OF INVENTION

Video streaming has become a dominant form of media consumption. However, deaf and hard-of-hearing individuals often face significant barriers to accessing video content. Traditional subtitles, while helpful, lack the expressiveness and nuance of sign language. Existing solutions, such as Picture-in-Picture (PiP) video tracks of sign language interpreters, suffer from limitations in compatibility, viewing experience, bandwidth consumption, and customization.

Therefore, techniques for generating and integrating sign language into video streams are desirable.

### BRIEF SUMMARY

A system and method are disclosed for generating and integrating sign language into video streams. A system for generating and integrating sign language into video streams may include: a server implementing a memory comprising non-transitory computer-readable storage medium and one or more processors, the memory comprising non-transitory computer-readable storage medium configured to store video data and subtitle data, the one or more processors configured to execute instructions stored on the non-transitory computer-readable storage medium to implement an NLP model and an AI model to: receive an input comprising a video, an audio associated with the video, and subtitle text associated with the video, generate, by the NLP model, an intermediate representation, convert the intermediate representation into a standardized transcription representation, generate, by the AI model, a sign language subtitle package comprising the standardized transcription representation and timing information, and deliver to a client the sign language subtitle package. In some examples, the intermediate representation is gloss. In some examples, the standardized transcription representation is in Hamburg Notation System. In some examples, the sign language subtitle package is being generated on-demand. In some examples, the sign language subtitle package is being generated as part of a video encoding and packaging workflow. In some examples, the sign language subtitle package comprises a text-based sign language subtitle track. In some examples, the one or more processors are further configured to execute instructions to customize the avatar according to one, or a combination, of a user-selected preference, a content provider-selected preference, and a content distributor-selected preference.

Another system for generating and integrating sign language into video streams may include: a client implementing a memory comprising non-transitory computer-readable storage medium and one or more processors, the memory comprising non-transitory computer-readable storage medium configured to store video data and subtitle data, the one or more processors configured to execute instructions stored on the non-transitory computer-readable storage medium to implement a video player, gesture translation module, and an avatar rendering engine to: receive a sign language subtitle package comprising a standardized transcription representation and timing information associated with a video, the sign language subtitle package being provided by a server-side processor, convert, by the gesture translation module, the standardized transcription representation into a signing gesture language description, render an avatar, by the avatar rendering engine, the avatar being animated using the signing gesture language description to perform sign language gestures in real time with the video, and play, by the video player, the video with the animated avatar being synchronized with the video. In some examples, the signing gesture language description is in a gesture markup language. In some examples, the gesture markup language is Signing Gesture Markup Language (SiGML). In some examples, the one or more processors are further configured to execute instructions to synchronize the avatar's animation speed with the video using the timing information from the sign language subtitle package. In some examples, the one or more processors are further configured to execute instructions to detect subtitle cues to determine when to display the avatar. In some examples, the one or more processors are further configured to execute instructions to customize the avatar according to one, or a combination, of a user-selected preference, a content provider-selected preference, and a content distributor-selected preference.

Still another system for generating and integrating sign language into video streams may include: a server-side processor configured to execute instructions stored on the non-transitory computer-readable storage medium to implement an NLP model and an AI model to: receive an input comprising a video, an audio associated with the video, and subtitle text associated with the video, generate, by the NLP model, an intermediate representation, covert the intermediate representation into a standardized transcription representation, generate, by the AI model, a sign language subtitle package comprising the standardized transcription representation and timing information, and deliver to a client the sign language subtitle package; and a client-side processor configured to execute instructions stored on the non-transitory computer-readable storage medium to implement a video player, gesture translation module, and an avatar rendering engine to: receive a sign language subtitle package comprising a standardized transcription representation and timing information associated with a video, convert the standardized transcription representation into a signing gesture language description, render an avatar, the avatar being animated using the signing gesture language description to perform sign language gestures in real time with the video, synchronize the avatar's animation speed with the video using the timing information from the sign language subtitle package, and play the video with the animated avatar being synchronized with the video.

A method for generating sign language subtitles for integrating sign language into video streams may include: receiving an input at a server, the server comprising an NLP model, the input comprising a video, an audio associated with the video, and a subtitle text associated with the video; generating, by the NLP model, an intermediate representation based on one, or a combination of, the video, the audio, and the subtitle text; converting the intermediate representation into a standardized transcription representation; generating a sign language subtitle package comprising the standardized transcription representation and timing information; and delivering to a client device the sign language subtitle package. In some examples, the intermediate representation is gloss. In some examples, converting the intermediate representation includes translating into a standardized sign language transcription system using an AI model. In some examples, the standardized transcription representation comprises a text-based sign language representation. In some examples, the standardized transcription representation is in Hamburg Notation System. In some examples, the client device is configured to play the video and to render and animate an avatar to perform sign language based on the sign language subtitle package. In some examples, the sign language subtitle package is being generated on-demand. In some examples, the sign language subtitle package is being generated as part of a video encoding and packaging workflow. In some examples, the method also includes customizing an avatar according to one, or a combination, of a user-selected preference, a content provider-selected preference, and a content distributor-selected preference, the avatar configured to perform sign language based on the sign language subtitle package.

Another method for integrating sign language into video streams comprising: receiving a sign language subtitle package at a client device, the client device comprising a video player, the sign language subtitle package comprising a standardized transcription representation and timing information associated with a video; converting the standardized transcription representation into a signing gesture language description; rendering an avatar, the avatar being animated using the signing gesture language description to perform sign language gestures in real time with the video; and playing the video with the animated avatar being synchronized with the video. In some examples, the sign language subtitle package is generated by a server-side processor. In some examples, the method also includes detecting subtitle cues to determine when to display the avatar. In some examples, the method also includes customizing the avatar according to one, or a combination, of a user-selected preference, a content provider-selected preference, and a content distributor-selected preference. In some examples, the signing gesture language description is in in a gesture markup language. In some examples, the gesture markup language is Signing Gesture Markup Language (SiGML).

### BRIEF DESCRIPTION OF THE DRAWINGS

Various non-limiting and non-exhaustive aspects and features of the present disclosure are described hereinbelow with references to the drawings, wherein:

FIGS. 1A-1B are simplified block diagrams illustrating exemplary architectures for generating and integrating sign language into video streams, in accordance with one or more embodiments.

FIG. 2A is a flow diagram illustrating an exemplary method for generating a sign language subtitle package for integrating sign language into a video stream, in accordance with one or more embodiments.

FIG. 2B is a flow diagram illustrating an exemplary method for integrating sign language into a video stream

FIG. 3A is a simplified block diagram of an exemplary computing system configured to implement the system shown in FIGS. 1A-1B and to perform steps of the method illustrated in FIGS. 2A-2B, in accordance with one or more embodiments.

FIG. 3B is a simplified block diagram of an exemplary distributed computing system implemented by a plurality of the computing devices, in accordance with one or more embodiments.

Like reference numbers and designations in the various drawings indicate like elements. Skilled artisans will appreciate that elements in the Figures are illustrated for simplicity and clarity, and have not necessarily been drawn to scale, for example, with the dimensions of some of the elements in the figures exaggerated relative to other elements to help to improve understanding of various embodiments. Common, well-understood elements that are useful or necessary in a commercially feasible embodiment are often not depicted in order to facilitate a less obstructed view of these various embodiments.

### DETAILED DESCRIPTION

The invention is directed to generating and integrating sign language into video streams. The systems described herein comprise a server side processor and a client side processor, the server side processor configured to implement a natural language processing (NLP) model and an artificial intelligence (AI) model, the client side processor configured to implement a video player, a signing gesture language translation module, and an avatar rendering module.

Techniques described herein leverage AI and NLP to convert text-based representations of spoken language (e.g., in/from a video) into a text-based sign language representation (i.e., a standardized transcription representation), which is then used to animate a customizable 3D avatar in real-time within a client device (e.g., a video player, a display device, etc.).

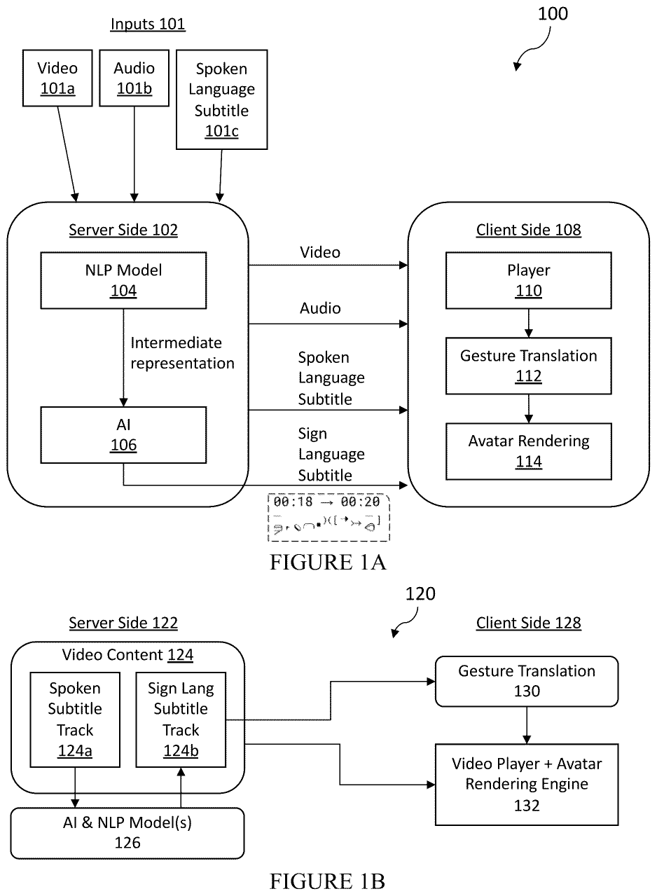

FIGS. 1A-1B are simplified block diagrams illustrating exemplary architectures for generating and integrating sign language into video streams, in accordance with one or more embodiments. In FIG. 1A, diagram 100 includes inputs 101, a server side 102, and a client side 108. Server side 102 (e.g., implemented in a physical server, virtual server, or other computing device) may comprise NLP model 104 configured to generate an intermediate representation, the intermediate representation being used by AI 106 to generate sign language subtitles. In some examples, inputs 101 may include video 101a, audio 101b, and spoken language subtitle 101c (e.g., a video asset with its associated audio and subtitle track). Audio 101b and spoken language subtitle 101c may be processed by NLP model 104 to generate an intermediate representation (e.g., gloss, or other brief translation or explanation of text into individual signs and simplified sign language grammar). In an example, NLP model 104 tokenizes the text from spoken language subtitle 101c, identifying individual words and phrases, and mapping them to their corresponding sign language equivalents in a simplified format. AI 106 may be configured to translate the intermediate representation into a standardized sign language transcription system (e.g., Hamburg Notation System (HamNoSys), or other text-based representation of sign language gestures), thereby converting the intermediate representation into a standardized transcription representation. Examples such as HamNoSys provide a compact, text-based representation of sign language gestures, including handshapes, locations, and movements. This translation process uses AI to learn complex relationships between simplified gloss and the more detailed HamNoSys notation. The standardized transcription representation may be packaged into a sign language subtitle package (i.e., “sign-track”), which may include timing information from spoken language subtitle 101c and/or other inputs 101. The sign-track may include a subtitle track in a standard format (e.g., WebVTT, SRT, TTML, ASS, and the like). The sign-track may be delivered to a client side 108 (e.g., a client device) as a separate sign language subtitle track alongside the video, for example, using a standard streaming protocol (e.g., DASH, HLS, etc.). In some examples, the associated audio 101b and spoken language subtitle 101c may be provided to the client side 108 along with the video and the sign-track. In some examples, the sign-track may be generated on-demand. In other examples, the sign-track may be generated as part of an existing video encoding and packaging workflow. A sign-track being a text-based subtitle track may be compatible with a variety of video players and streaming technologies, thereby eliminating the need for special player modifications. The text-based subtitle track also requires less bandwidth than having a separate video track (e.g., of a person signing the dialog in the video), also reducing storage and encoding costs. Since subtitles are easier to update than video tracks, any errors are easily fixed (e.g., tweaks easily made).

In some examples, client side 108 may include player 110, gesture translation module 112, and avatar rendering engine 114. When a video containing a sign-track is played by player 110 and the sign-track is activated (e.g., automatically by the timing information or manually by a user selection of a signing option), a customizable 3D avatar may be initialized with or within the video player. In some examples, the gesture translation module 112 may be configured to convert the standardized transcription representation from the sign-track package into a signing gesture language description (e.g., Signing Gesture Markup Language (SiGML), and other sign language gesture description languages). SiGML is an XML-based language used to describe sign language gestures for digital applications. Any language with similar ability to describe sign language gestures for digital applications may be used to generate the signing gesture language description.

In some examples, avatar rendering engine 114 may comprise a rendering and animation engine configured to render and animate a 3D avatar. The signing gesture language description (e.g., SiGML description) may be used by avatar rendering engine 114, along with the timing information from the sign-track package, to render and animate a 3D avatar, causing the avatar to perform the corresponding sign language gestures in real-time, synchronized with the video. In some examples, a synchronization mechanism may be implemented to adjust the animation speed of the 3D avatar based on the timing information in the sign-track to ensure that the sign language gestures of the 3D avatar are synchronized with the associated audio and video content. In some examples, sign-track subtitle cues (i.e., timing) also may be used to determine when to display the 3D avatar. For example, if a video contains a segment (e.g., a number of frames) that contains that does not contain any dialog, or spoken language subtitles, the 3D avatar may not appear during such a segment (e.g., during an opening credits section, an action sequence without dialog, closing credits, and the like). The timing information may indicate when dialog will begin and thereby trigger the appearance of the avatar when, or within a given time frame before, the dialog begins. In some examples, the avatar also may be customized according to a user-selected preference, content provider-selected preference, content distributor-selected preference, or other selected preference, for example, in appearance (e.g., style, coloring, gender, size, age, etc.), gesture (e.g., style, type), and position. In some examples, the 3D avatar may be overlaid with the video being played to avoid the visual distraction and limitations of other implementations (e.g., picture-in-picture (PiP). Since the avatar's animation is driven by subtitle cues, this technique is easy to integrate into any video player, many of which are already capable of exposing subtitle cues.

In FIG. 1B, diagram 120 shows another framework for generating and integrating sign language into video streams, including server side 122 and client side 128. On server side 122, video content 124 may include spoken subtitle track 124a, which is provided to AI and NLP model(s) 126 to generate sign language subtitle track 124b (e.g., a sign-track package, as described herein). On client side 128, gesture translation module 130 may be configured to translate sign language subtitle track 124b into a signing gesture language description (e.g., SiGML description) to be used by video player and avatar rendering engine 132 to render and animate a 3D avatar to sign the dialog along with video content 124, which has also been provided to video player and avatar rendering engine 132 to be played. Each element in diagram 120 of FIG. 1B that have the same or similar name or designation as in diagram 100 of FIG. 1A may have the same or similar function(s) and feature(s) as described above for its corresponding element.

### Example Methods

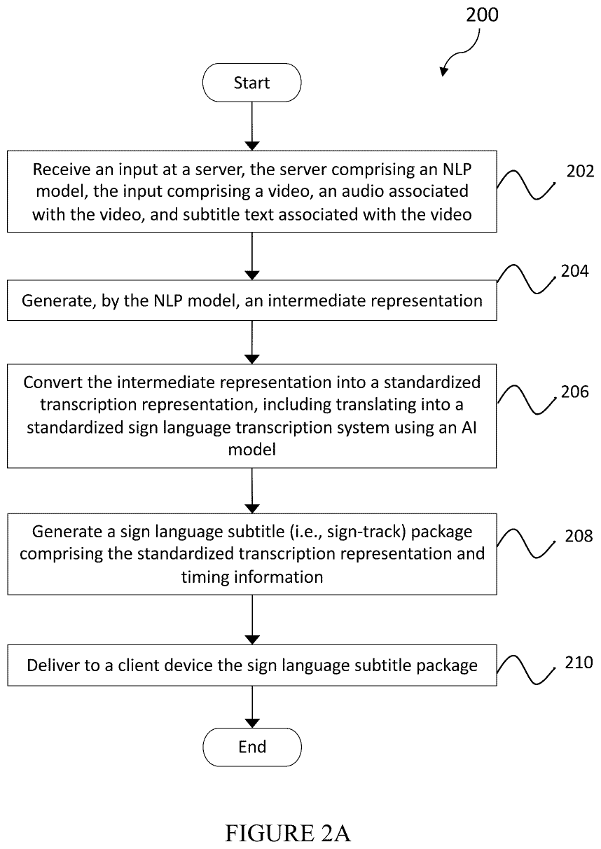

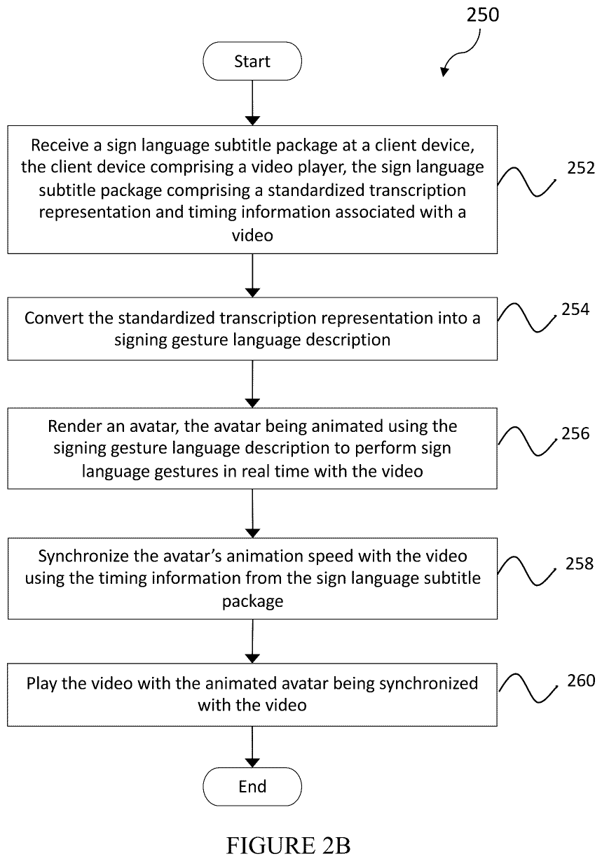

FIG. 2A is a flow diagram illustrating an exemplary method for generating a sign language subtitle package for integrating sign language into a video stream, in accordance with one or more embodiments. Method 200 begins with receiving an input at a server at step 202, the server comprising an NLP model, the input comprising a video, an audio associated with the video, and a subtitle text associated with the video. An intermediate representation may be generated by the NLP model at step 204. In some examples, the intermediate representation may be gloss. The intermediate representation may be converted into a standardized transcription representation at step 206, including translating into a standardized sign language transcription system using an AI model. In some examples, the standardized transcription representation may be in HamNoSys notation. A sign language subtitle (i.e., sign-track) package may be generated comprising the standardized transcription representation and timing information at step 208. In some examples, the sign-track package may comprise a text-based sign language subtitle track. The sign language subtitle package may be delivered to a client device at step 210. In some examples, the client device may include a video player, a gesture translation module, and an avatar rendering engine, as described herein.

FIG. 2B is a flow diagram illustrating an exemplary method for integrating sign language into a video stream. In method 250, a sign language subtitle package may be received at a client device at step 252, the client device comprising a video player, the sign language subtitle package comprising a standardized transcription representation (e.g., in HamNoSys notation) and timing information associated with a video. The standardized transcription representation may be converted (e.g., translated) into a signing gesture language description (e.g., SiGML) at step 254. An avatar may be rendered at step 256, the avatar being animated using the signing gesture language description to perform sign language gestures in real time with the video. In some examples, the avatar's animation speed may be synchronized with the video at step 258, using the timing information from the sign language subtitle package. The animated avatar may be played with the video at step 260, the animated avatar being synchronized with the video. In some examples, the animated avatar comprises a 3D avatar.

### Example Computing Systems

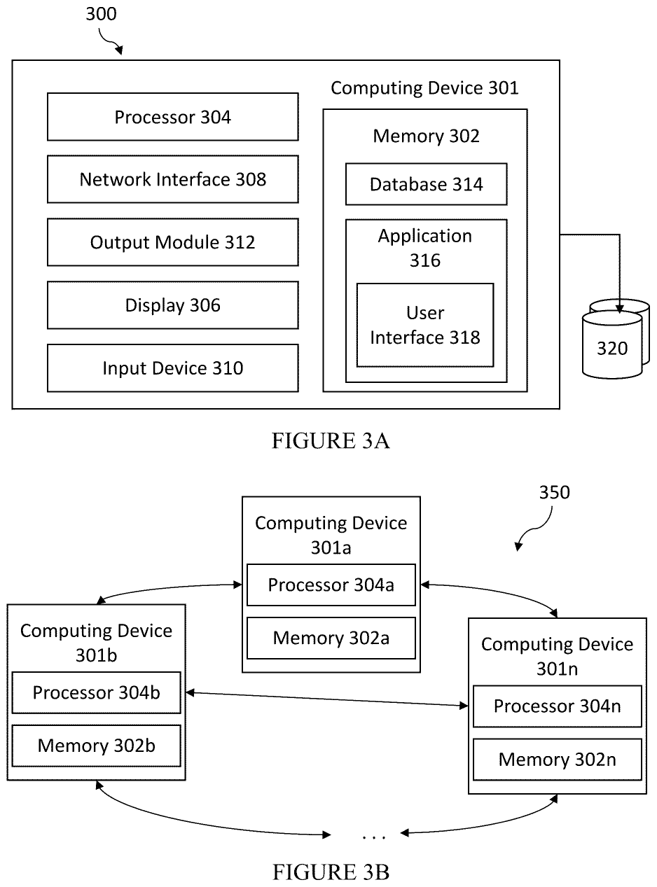

FIG. 3A is a simplified block diagram of an exemplary computing system configured to implement the system shown in FIGS. 1A-1B and to perform steps of the method illustrated in FIGS. 2A-2B, in accordance with one or more embodiments. In one embodiment, computing system 300 may include computing device 301 and storage system 320. Storage system 320 may comprise a plurality of repositories and/or other forms of data storage, and it also may be in communication with computing device 301. In another embodiment, storage system 320, which may comprise a plurality of repositories, may be housed in one or more of computing device 301. In some examples, storage system 320 may store video data (e.g., frames, segments, subtitle tracks, audio data, etc.), codecs, user preferences, content preferences, instructions, programs, AI/ML models, NLP models, and other various types of information as described herein. This information may be retrieved or otherwise accessed by one or more computing devices, such as computing device 301, in order to perform some or all of the features described herein. Storage system 320 may comprise any type of computer storage, such as a hard-drive, memory card, ROM, RAM, DVD, CD-ROM, write-capable, and read-only memories. In addition, storage system 320 may include a distributed storage system where data is stored on a plurality of different storage devices, which may be physically located at the same or different geographic locations (e.g., in a distributed computing system such as system 350 in FIG. 3B). Storage system 320 may be networked to computing device 301 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 301 also may include a memory 302. Memory 302 may comprise a storage system configured to store a database 314 and an application 316. Application 316 may include instructions which, when executed by a processor 304, cause computing device 301 to perform various steps and/or functions, as described herein. Application 316 further includes instructions for generating a user interface 318 (e.g., graphical user interface (GUI)). Database 314 may store various algorithms and/or data, including neural networks, AI/ML models, NLP models, data regarding encoding, video content, subtitle tracks, audio data, user preferences, among other types of data. Memory 302 may include any non-transitory computer-readable storage medium for storing data and/or software that is executable by processor 304, and/or any other medium which may be used to store information that may be accessed by processor 304 to control the operation of computing device 301.

Computing device 301 may further include a display 306, a network interface 308, an input device 310, and/or an output module 312. Display 306 may be any display device by means of which computing device 301 may output and/or display data. Network interface 308 may be configured to connect to a network using any of the wired and wireless short range communication protocols described above, as well as a cellular data network, a satellite network, free space optical network and/or the Internet. Input device 310 may be a mouse, keyboard, touch screen, voice interface, and/or any or other hand-held controller or device or interface by means of which a user may interact with computing device 301. Output module 312 may be a bus, port, and/or other interface by means of which computing device 301 may connect to and/or output data to other devices and/or peripherals.

In one embodiment, computing device 301 is a data center or other control facility (e.g., configured to run a distributed computing system as described herein), and may communicate with a media playback device or other video player or client device. As described herein, system 300, and particularly computing device 301, may be used for encoding video, analyzing, generating metadata, natural language processing, implementing AI models, generating subtitles, gesture translation, avatar rendering, and otherwise implementing steps in generating and integrating sign language into video streams, as described herein. Various configurations of system 300 are envisioned, and various steps and/or functions of the processes described herein may be shared among the various devices of system 300 or may be assigned to specific devices.

FIG. 3B is a simplified block diagram of an exemplary distributed computing system implemented by a plurality of the computing devices, in accordance with one or more embodiments. System 350 may comprise two or more computing devices 301a-n. In some examples, each of 301a-n may comprise one or more of processors 304a-n, respectively, and one or more of memory 302a-n, respectively. Processors 304a-n may function similarly to processor 304 in FIG. 3A, as described above. Memory 302a-n may function similarly to memory 302 in FIG. 3A, as described above. One or more computing devices 301a-n may implement a server-side processer, as described herein. One or more other of computing devices 301a-n may implement a client-side processor or component, as described herein.

While specific examples have been provided above, it is understood that the present invention can be applied with a wide variety of inputs, thresholds, ranges, and other factors, depending on the application. For example, the time frames, rates, ratios, and ranges provided above are illustrative, but one of ordinary skill in the art would understand that these time frames and ranges may be varied or even be dynamic and variable, depending on the implementation.

As those skilled in the art will understand a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A system for generating and integrating sign language into video streams comprising:
a server implementing a memory comprising non-transitory computer-readable storage medium and one or more processors,
the memory comprising non-transitory computer-readable storage medium configured to store video data and subtitle data,
the one or more processors configured to execute instructions stored on the non-transitory computer-readable storage medium to implement an NLP model and an AI model to:
receive an input comprising a video, an audio associated with the video, and subtitle text associated with the video,
generate, by the NLP model, an intermediate representation,
convert the intermediate representation into a standardized transcription representation,
generate, by the AI model, a sign language subtitle package comprising the standardized transcription representation and timing information, and
deliver to a client the sign language subtitle package.

2. The system of claim 1, wherein the intermediate representation is gloss.

3. The system of claim 1, wherein the standardized transcription representation is in Hamburg Notation System.

4. The system of claim 1, wherein the sign language subtitle package is being generated on-demand.

5. The system of claim 1, wherein the sign language subtitle package is being generated as part of a video encoding and packaging workflow.

6. The method of claim 1, wherein the sign language subtitle package comprises a text-based sign language subtitle track.

7. The method of claim 1, wherein the one or more processors are further configured to execute instructions to customize the avatar according to one, or a combination, of a user-selected preference, a content provider-selected preference, and a content distributor-selected preference.

8. A system for generating and integrating sign language into video streams comprising:
a client implementing a memory comprising non-transitory computer-readable storage medium and one or more processors,
the memory comprising non-transitory computer-readable storage medium configured to store video data and subtitle data,
the one or more processors configured to execute instructions stored on the non-transitory computer-readable storage medium to implement a video player, gesture translation module, and an avatar rendering engine to:
receive a sign language subtitle package comprising a standardized transcription representation and timing information associated with a video, the sign language subtitle package being provided by a server-side processor,
convert, by the gesture translation module, the standardized transcription representation into a signing gesture language description,
render an avatar, by the avatar rendering engine, the avatar being animated using the signing gesture language description to perform sign language gestures in real time with the video, and
play, by the video player, the video with the animated avatar being synchronized with the video.

9. The system of claim 8, wherein the signing gesture language description is in a gesture markup language.

10. The system of claim 9, wherein the gesture markup language is Signing Gesture Markup Language (SiGML).

11. The system of claim 8, wherein the one or more processors are further configured to execute instructions to synchronize the avatar's animation speed with the video using the timing information from the sign language subtitle package.

12. The system of claim 8, wherein the one or more processors are further configured to execute instructions to detect subtitle cues to determine when to display the avatar.

13. The system of claim 8, wherein the one or more processors are further configured to execute instructions to customize the avatar according to one, or a combination, of a user-selected preference, a content provider-selected preference, and a content distributor-selected preference.

14. A system for generating and integrating sign language into video streams comprising:
a server-side processor configured to execute instructions stored on the non-transitory computer-readable storage medium to implement an NLP model and an AI model to:
receive an input comprising a video, an audio associated with the video, and subtitle text associated with the video,
generate, by the NLP model, an intermediate representation,
covert the intermediate representation into a standardized transcription representation,
generate, by the AI model, a sign language subtitle package comprising the standardized transcription representation and timing information, and
deliver to a client the sign language subtitle package; and
a client-side processor configured to execute instructions stored on the non-transitory computer-readable storage medium to implement a video player, gesture translation module, and an avatar rendering engine to:
receive a sign language subtitle package comprising a standardized transcription representation and timing information associated with a video,
convert the standardized transcription representation into a signing gesture language description,
render an avatar, the avatar being animated using the signing gesture language description to perform sign language gestures in real time with the video,
synchronize the avatar's animation speed with the video using the timing information from the sign language subtitle package, and
play the video with the animated avatar being synchronized with the video.

15. A method for generating sign language subtitles for integrating sign language into video streams comprising:
receiving an input at a server, the server comprising an NLP model, the input comprising a video, an audio associated with the video, and a subtitle text associated with the video;
generating, by the NLP model, an intermediate representation based on one, or a combination of, the video, the audio, and the subtitle text;
converting the intermediate representation into a standardized transcription representation;
generating a sign language subtitle package comprising the standardized transcription representation and timing information; and
delivering to a client device the sign language subtitle package.

16. The method of claim 15, wherein the intermediate representation is gloss.

17. The method of claim 15, wherein converting the intermediate representation includes translating into a standardized sign language transcription system using an AI model.

18. The method of claim 15, wherein the standardized transcription representation comprises a text-based sign language representation.

19. The method of claim 15, wherein the standardized transcription representation is in Hamburg Notation System.

20. The method of claim 15, wherein the client device is configured to play the video and to render and animate an avatar to perform sign language based on the sign language subtitle package.

21. The method of claim 15, wherein the sign language subtitle package is being generated on-demand.

22. The method of claim 15, wherein the sign language subtitle package is being generated as part of a video encoding and packaging workflow.

23. The method of claim 15, further comprising customizing an avatar according to one, or a combination, of a user-selected preference, a content provider-selected preference, and a content distributor-selected preference, the avatar configured to perform sign language based on the sign language subtitle package.

24. A method for integrating sign language into video streams comprising:
receiving a sign language subtitle package at a client device, the client device comprising a video player, the sign language subtitle package comprising a standardized transcription representation and timing information associated with a video;
converting the standardized transcription representation into a signing gesture language description;
rendering an avatar, the avatar being animated using the signing gesture language description to perform sign language gestures in real time with the video; and
playing the video with the animated avatar being synchronized with the video.

25. The method of claim 23, wherein the sign language subtitle package is generated by a server-side processor.

26. The method of claim 23, further comprising detecting subtitle cues to determine when to display the avatar.

27. The method of claim 23, further comprising customizing the avatar according to one, or a combination, of a user-selected preference, a content provider-selected preference, and a content distributor-selected preference.

28. The method of claim 23, wherein the signing gesture language description is in in a gesture markup language.

29. The system of claim 28, wherein the gesture markup language is Signing Gesture Markup Language (SiGML).
